(19) United States
(12) Patent Application Publication
(10) Pub. No.: US 2025/0118486 A1
(43) Pub. Date: Apr. 10, 2025

(54) COIL COMPONENT

(71) Applicant: SAMSUNG ELECTRO-MECHANICS CO., LTD., Suwon-si (KR)

(72) Inventors: Min Ji CHO, Suwon-si (KR); Jae Hun KIM, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/899,157

(22) Filed: Sep. 27, 2024

(30) Foreign Application Priority Data
Oct. 4, 2023 (KR) 10-2023-0131516

(51) Int. Cl. H01F 27/32; H01F 27/30

(52) U.S. Cl. CPC H01F 27/323; H01F 27/306; H01F 27/324

(57) ABSTRACT

A coil component includes a body, a support member disposed within the body, a coil disposed on the support member, and including a lower surface in contact with the support member, an upper surface facing the lower surface, an insulating wall covering a side of the coil and filling a gap between respective turns of the coil, an insulating film disposed between adjacent the insulating walls and covering the upper surface of the coil, and an external electrode disposed on the body. The insulating wall includes a plurality of layers, with an interface therebetween. A height of the insulating wall is greater than or equal to a height of an upper surface of the insulating film.

### CROSS-REFERENCE TO RELATED APPLICATION(S)

This application claims the benefit of priority to Korean Patent Application No. 10-2023-0131516 filed on Oct. 4, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in electronic devices along with resistors and capacitors.

As electronic devices are increasingly implemented with high-performance and are miniaturized, electronic components used in electronic devices are also increasing in number and becoming smaller.

On the other hand, to improve inductance characteristics of coil components within a limited size, it is advantageous to increase the number of turns of the coil, increase the area of a central core, and increase an effective volume of a magnetic material.

However, coils having a high aspect ratio may be suitable for implementing the above characteristics, but problems such as difficulties in the plating process and current leakage through magnetic materials between adjacent turns may occur.

### SUMMARY

An aspect of the present disclosure is to easily form a coil having a high aspect ratio through an insulating wall and to prevent current leakage between adjacent turns.

An aspect of the present disclosure is to improve inductance characteristics of a coil component by securing a space in a body in which a magnetic material may be disposed.

According to an aspect of the present disclosure, a coil component includes a body including a first surface and a second surface opposing each other in a first direction, a support member disposed within the body and having one surface and the other surface facing each other, a coil disposed on the support member, having a plurality of turns, and including a lower surface in contact with the support member, an upper surface facing the lower surface, and a side connecting the upper surface and the lower surface, an insulating wall covering the side of the coil and filling between respective turns of the coil, an insulating film disposed between the insulating wall and the insulating wall and covering the upper surface of the coil, and an external electrode disposed on the body and connected to the coil. The insulating wall includes a plurality of layers, and an interface is provided between respective layers of the insulating wall. A height of the insulating wall in the first direction is greater than or equal to a height of an upper surface of the insulating film in the first direction, with respect to one surface of the support member.

According to an aspect of the present disclosure, a coil component includes a body including a first surface and a second surface opposing each other in a first direction, a support member disposed within the body, a coil disposed on the support member, having a plurality of turns, and including a lower surface in contact with the support member and an upper surface facing the lower surface, an insulating wall disposed between respective turns of the coil, an insulating film disposed between the insulating walls and interposed between the upper surface of the coil and the body, and an external electrode disposed on the body and connected to the coil. The insulating wall includes a plurality of layers, and an interface is provided between respective layers of the insulating wall. The upper surface of the coil has a concave shape toward the support member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment;

FIG. 2 is a cross-sectional view taken along line I-I′ of FIG. 1;

FIG. 3 is an enlarged view of area A1 in FIG. 2;

FIG. 4 is a cross-sectional view taken along line II-II′ of FIG. 1;

FIG. 5 illustrates a first modification of the first embodiment and is a view corresponding to FIG. 4;

FIG. 6 illustrates a second modification of the first embodiment and is a view corresponding to FIG. 3;

FIG. 7 illustrates a third modification of the first embodiment and is a view corresponding to FIG. 3;

FIG. 8 illustrates a fourth modification of the first embodiment and is a view corresponding to FIG. 3;

FIG. 9 illustrates a coil component according to a second embodiment, and is a diagram corresponding to FIG. 2;

FIG. 10 is an enlarged view of area B of FIG. 9;

FIG. 11 illustrates a modification of the second embodiment and is a diagram corresponding to FIG. 10;

FIG. 12 is a diagram schematically illustrating a portion of a process of manufacturing the coil component illustrated in FIG. 4; and

FIG. 13 is a diagram schematically illustrating a portion of a process of manufacturing a coil component including a coil with a multilayer structure as illustrated in FIG. 7.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, step, operation, component, part, or combination thereof described in the specification exists, and it should be understood that this does not preclude the possibility of addition or existence of one or more other features or numbers, steps, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, a T direction may be defined as a first direction or a thickness direction, an L direction may be defined as a second direction or a length direction, and a W direction may be defined as a third direction or a width direction.

Hereinafter, a coil component according to an embodiment will be described in detail with reference to the accompanying drawings, and in the description with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal and the like.

For example, in electronic devices, the coil component may be used as a power inductor, a high frequency (HF) inductor, a general bead, a high frequency bead (GHz Bead), a common mode filter, or the like.

### First Embodiment

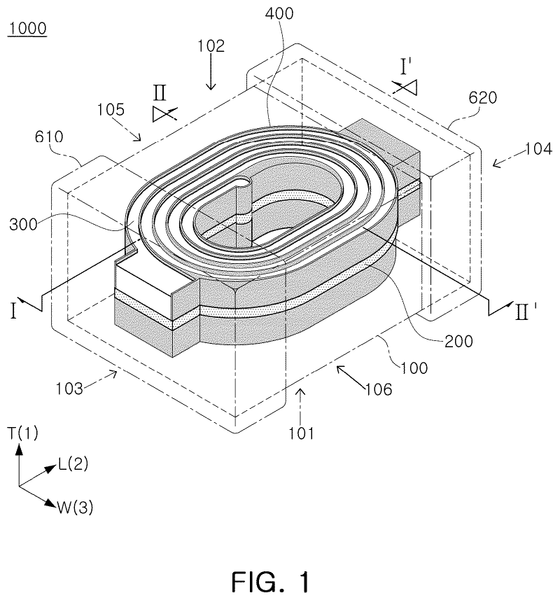

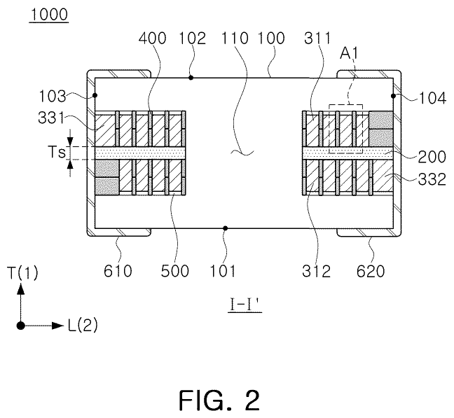

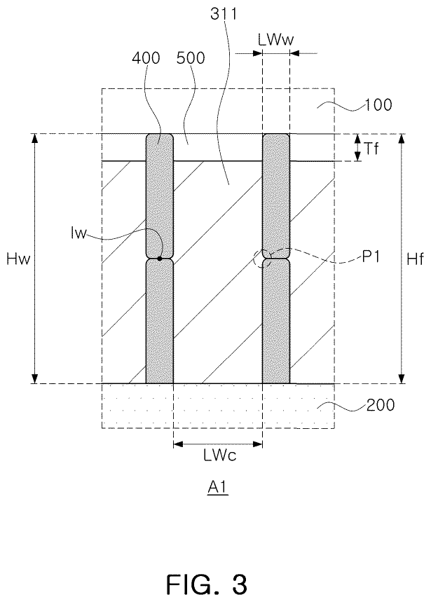

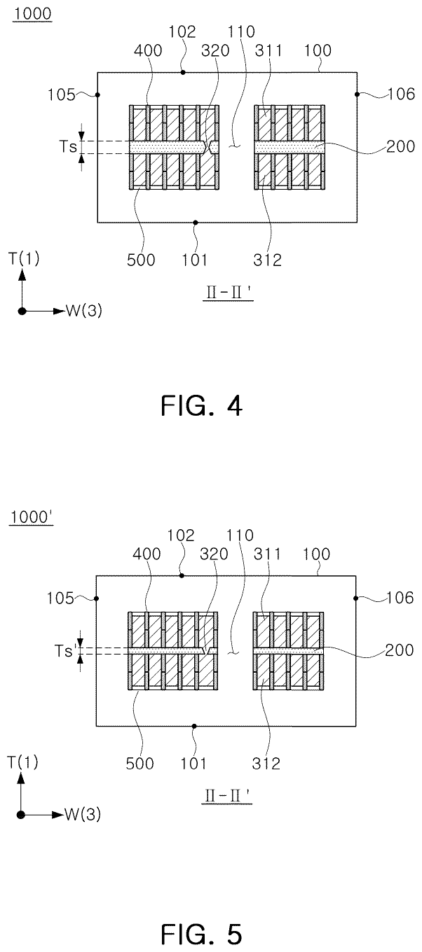

FIG. 1 is a perspective view schematically illustrating a coil component 1000 according to a first embodiment. FIG. 2 is a cross-sectional view taken along line I-I′ of FIG. 1. FIG. 3 is an enlarged view of area A1 in FIG. 2. FIG. 4 is a cross-sectional view taken along line II-II′ of FIG. 1.

On the other hand, to more clearly illustrate the coupling between components, the insulating film 500 and the external insulating layer applicable to this embodiment are omitted in FIG. 1.

Referring to FIGS. 1 to 4, the coil component 1000 according to this embodiment may include a body 100, a support member 200, a coil 300, an insulating wall 400, an insulating film 500, and external electrodes 610 and 620.

The coil component 1000 according to this embodiment may stably form a coil with a high aspect ratio by including an insulating wall 400 that fills between respective turns of the coil 300. The insulation reliability between respective turns may be improved.

In addition, by forming the insulating wall 400 in a plurality of layers, the coil 300 with a higher aspect ratio may be formed, so that the inductance capacity may be increased as the number of turns of the coil 300 increases within a limited size, and as the cross-sectional area of the coil 300 increases, Rdc characteristics may also be improved.

On the other hand, the coil component 1000 according to this embodiment may include an insulating film 500 covering the upper surface of the coil 300. By forming the height of the upper surface of the insulating film 500 to be the same height or lower than that of the end of the insulating wall 400, more space is secured where the magnetic material of the body 100 may be placed, and the inductance characteristics may be improved as the effective volume increases.

The line width LWw of the insulating wall 400 disposed between respective turns of the coil 300 in this embodiment is in a range from 3 μm to 8 μm, the thickness of the insulating film 500 in the first direction (T) is in a range from 6 μm to 8 μm, and the thickness of the support member 200 in the first direction (T) may be 50 μm or less, but is not limited thereto.

Below, the main components constituting the coil component 1000 according to this embodiment will be described in detail.

The body 100 has the appearance of the coil component 1000 according to this embodiment, and a support member 200, a coil 300, an insulating wall 400, and an insulating film 500 may be embedded therein.

The body 100 may be formed overall into a hexahedral shape.

The body 100 has a first surface 101 and a second surface 102 opposing each other in the thickness direction (T, first direction), a third surface 103 and a fourth surface 104 opposing each other in the longitudinal direction (L, second direction), and a fifth surface 105 and a sixth surface 106 opposing each other in the width direction (W, third direction). Each of the third to sixth surfaces 103, 104, 105, and 106 of the body 100, and corresponds to the wall surface of the body 100 connecting the first surface 101 and the second surface 102 of the body 100.

The body 100, by way of example, may be formed to have a length of 2.5 mm, a width of 2.0 mm, and a thickness of 0.8 mm, or to have a length of 2.0 mm, a width of 1.2 mm and a thickness of 0.6 mm, or to have a length of 1.6 mm, a width of 0.8 mm, and a thickness of 0.6 mm, or to have a length of 1.6 mm, a width of 0.8 mm, and a thickness of 0.4 mm, or to have a length of 1.4 mm, a width of 1.2 mm, and a thickness of 0.65 mm, or to have a length of 1.0 mm, a width of 0.7 mm, and a thickness of 0.65 mm, or to have a length of 0.8 mm, a width of 0.4 mm, and a thickness of 0.65 mm, or to have a length of 0.8 mm, a width of 0.4 mm, and a thickness of 0.5 mm, but the present disclosure is not limited thereto. On the other hand, the above-described exemplary values for the length, width, and thickness of the coil component 1000 refer to values that do not reflect process errors, and the values within the range that may be recognized as process errors should be considered to correspond to the above-described exemplary values.

Based on the optical microscope image or Scanning Electron Microscope (SEM) image of a length direction (L)-thickness direction (T) cross-section taken from a width direction (W) central portion of the coil component 1000, the length of the coil component 1000 described above may refer to a maximum value of dimensions of a plurality of line segments obtained by connecting two outermost boundary lines of the coil component 1000, which face in the length direction (L) illustrated in the image, to each other to be parallel to the length direction (L) and which are spaced apart from each other in the thickness direction. Alternatively, the length of the coil component 1000 may refer to a minimum value among the dimensions of the plurality of respective line segments described above. Alternatively, the length of the coil component 1000 may refer to an arithmetic mean value of at least three or more of the dimensions of the plurality of respective line segments described above. In this case, the plurality of line segments parallel to the length direction L may be equally spaced from each other in the thickness direction T, but the scope of the present disclosure is not limited thereto.

Based on the optical microscope image or Scanning Electron Microscope (SEM) image of the length direction (L)-thickness direction (T) cross-section taken from the central portion of the coil component 1000 in the width direction (W), the thickness of the coil component 1000 described above may refer to a maximum value of dimensions of a plurality of respective line segments obtained by connecting two outermost boundary lines of the coil component 1000, which face in the thickness direction (T) illustrated in the image, to each other to be in parallel to the thickness direction (T) and which are spaced apart from each other in the length direction (L). Alternatively, the thickness of the coil component 1000 may refer to a minimum value among the dimensions of the plurality of respective line segments described above. Alternatively, the thickness of the coil component 1000 may refer to an arithmetic mean value of at least three or more of the dimensions of the plurality of respective line segments described above. In this case, the plurality of line segments parallel to the thickness direction T may be equally spaced from each other in the length direction L, but the scope of the present disclosure is not limited thereto.

Based on the optical microscope image or Scanning Electron Microscope (SEM) image of the length direction (L)-width direction (W) cross-section taken from a central portion of the coil component 1000 in the thickness direction (T), the width of the coil component 1000 described above may refer to a maximum value among dimensions of a plurality of respective line segments, which are provided by connecting two outermost boundary lines of the coil component 1000 facing in the width direction (W), illustrated in the image, to be parallel to the width direction (W), and which are spaced apart from each other in the length direction (L). Alternatively, the width of the coil component 1000 may refer to a minimum value among the dimensions of the plurality of respective line segments described above. Alternatively, the width of the coil component 1000 may refer to an arithmetic mean value of at least three or more of the dimensions of the plurality of respective line segments described above. In this case, the plurality of line segments parallel to the width direction W may be equally spaced from each other in the length direction L, but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include a magnetic material and a resin. In detail, the body 100 may be formed by laminating one or more magnetic composite sheets in which a magnetic material is dispersed in a resin. However, the body 100 may have a structure other than a structure in which a magnetic material is dispersed in a resin. For example, the body 100 may be formed of a magnetic material such as ferrite or may be formed of a non-magnetic material.

The magnetic material may be ferrite or metallic magnetic powder.

Ferrite may be at least one of, for example, spinel-type ferrites such as Mg—Zn, Mn—Zn, Mn—Mg, Cu—Zn, Mg—Mn—Sr, Ni—Zn, and the like, hexagonal ferrites such as Ba—Zn, Ba—Mg, Ba—Ni, Ba—Co, and Ba—Ni—Co, and the like, garnet-type ferrites such as Y and the like, and Li ferrites.

The magnetic metal powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic metal powder may amorphous or crystalline. For example, the magnetic metal powder may be an Fe—Si—B—Cr-based amorphous alloy powder, but is not necessarily limited thereto.

Ferrite and magnetic metal powder may have an average diameter of about 0.1 μm to 30 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

The resin may include, but is not limited to, epoxy, polyimide, a liquid crystal polymer, or the like, alone or in combination.

The body 100 has a core 110 penetrating a support member 200 and a coil 300. The core 110 may be formed by filling the through hole of the support member 200 with a magnetic composite sheet, but is not limited thereto.

The support member 200 may be disposed within the body 100. The support member 200 is configured to support the coil 300 and the insulating wall 400. On the other hand, the support member 200 may be excluded depending on an embodiment, such as when the coil 300 corresponds to a wound coil or has a coreless structure.

The support member 200 may be formed of an insulating material including a thermosetting insulating resin such as an epoxy resin, a thermoplastic insulating resin such as polyimide, or a photosensitive insulating resin, or may be formed of an insulating material impregnated with a reinforcing material such as glass fiber or an inorganic filler in this insulating resin. For example, the support member 200 may include a Prepreg, Ajinomoto Build-up Film (ABF), FR-4, Bismaleimide Triazine (BT) resin, Photo Imageable Dielectric (PID), and Copper Clad Laminate (CCL), but the present disclosure is not limited thereto.

As an inorganic filler, at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), carbonic acid or calcium (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the support member 200 is formed of an insulating material including a reinforcing material, the support member 200 may provide more excellent rigidity. When the support member 200 is formed of an insulating material that does not contain glass fibers, it may be advantageous to reduce the thickness of the component by reducing an overall thickness (referring to a sum of respective dimensions of the coil 300 and the support member 200 in the second direction T in FIG. 1) of the support member 200 and the coil 300. When the support member 200 is formed of an insulating material including a photosensitive insulating resin, since the number of processes for forming the coil 300 is reduced, it may be advantageous to reduce production costs, and fine vias 320 may be formed.

The thickness Ts of the support member 200 in the first direction T may be 50 μm or less, and in detail, may be in a range from 10 μm to 50 μm, but is not limited thereto.

In the coil component 1000 according to this embodiment, the thickness Ts of the support member 200 is formed as thin as 50 μm or less, thereby securing space to form the coil 300 with a high aspect ratio within the same size, and since a space for the magnetic material in the body 100 may be secured, the effective volume may be increased and the inductance characteristics may be improved.

The coil 300 of this embodiment may be disposed on the support member 200. Additionally, the coil 300 of this embodiment may be insulated from the body 100 by the insulating wall 400 and the insulating film 500.

The coil 300 is embedded in the body 100 and exhibits the characteristics of a coil component. For example, when the coil component 1000 according to this embodiment is used as a power inductor, the coil 300 stores the electric field as a magnetic field to maintain an output voltage, thereby stabilizing the power of an electronic device.

The coil 300 is formed on at least one of two opposing surfaces of the support member 200 and may form a plurality of turns. The coil 300 may include a lower surface in contact with the support member 200, an upper surface facing the lower surface, and a side connecting the upper surface and the lower surface, and the side of the coil 300 may be covered by the insulating wall 400, and the upper surface of the coil 300 may be covered by the insulating film 500.

Referring to FIG. 3, the coil component 1000 according to this embodiment has an insulating wall 400 formed of a plurality of layers. In this case, the side of the coil 300 may include at least one protrusion P1 protruding toward the interface Iw between respective layers of the insulating wall 400.

In the case of the protrusion P1, a region where the line width LWw of the insulating wall 400 is narrowed in the interface Iw area of each layer when respective layers of the insulating wall 400 are sequentially stacked may be generated, and afterwards, when forming the coil 300 through electrolytic plating, the metal component fills the area, thereby forming the protrusion P1.

When the protrusion P1 is formed on the side of the coil 300, the line width LWc at each turn of the coil 300 may be maximum in an area adjacent to the protrusion P1. For example, the line width LWw of the insulating wall 400 in the area adjacent to the protrusion P1 may be minimum, and accordingly, the line width LWc of the coil 300 in the area adjacent to the protrusion P1 may be maximum.

In this case, based on an optical microscope image or a scanning electron microscope (SEM) image of the second direction (L)-first direction (T) cross section taken from the central portion of the third direction (W) of the coil component 1000, as an example, the line width LWc of the coil 300 may refer to the arithmetic average values of at least three or more of respective dimensions of a plurality of line segments connecting the outermost border of each turn of the first coil pattern 311 illustrated in the image in the second direction (L) and spaced apart from each other in the first direction (T). In this case, the plurality of line segments may be equally spaced from each other, but the scope of the present disclosure is not limited thereto.

On the other hand, the line width LWw of the insulating wall 400 may also be measured in a similar manner.

The coil 300 of this embodiment may include coil patterns 311 and 312, vias 320, and lead-out portions 331 and 332.

In detail, referring to FIGS. 2 and 4, the coil 300 of this embodiment may include a first coil pattern 311 disposed on one surface of the support member 200, a first lead-out portion 331 extending from the outer end of the first coil pattern 311 to the third surface 103 of the body 100, a second coil pattern 332 disposed on the other surface of the support member 200, a second lead-out portion 332 extending from the outer end of the second coil pattern 312 to the fourth surface 104 of the body 100, and a via 320 connecting the first coil pattern 311 and the second coil pattern 312.

Referring to FIGS. 1 to 4, the first coil pattern 311 and the second coil pattern 312 are each disposed on both sides of the support member 200 facing each other, and may be in the form of a plane spiral forming a plurality of turns around the core 110 of the body 100.

The first coil pattern 311 may be disposed on one surface of the support member 200 to form a plurality of turns around the core 110. The end of the outermost turn of the first coil pattern 311 may be connected to the first lead-out portion 331 extending to the third surface 103 of the body 100.

Additionally, the second coil pattern 312 may be disposed on the other surface of the support member 200 to form at least a plurality of turns about the core 110 as an axis. The end of the outermost turn of the second coil pattern 312 may be connected to the second lead-out portion 332 extending to the fourth surface 104 of the body 100.

An insulating wall 400 may be disposed between respective turns of the coil patterns 311 and 312. The insulating wall 400 may prevent short circuits or current leakage between adjacent turns by filling the space between respective turns of the coil patterns 311 and 312.

In addition, an insulating film 500 is disposed on the upper surface of the coil patterns 311 and 312 between the insulating walls 400, so that the coil patterns 311 and 312 may be insulated from the body 100.

Referring to FIGS. 1 and 2, the lead-out portions 331 and 332 may extend from the coil patterns 311 and 312 to the third surface 103 or the fourth surface 104 of the body 100.

In detail, the first lead-out portion 331 may be connected to the outer end of the first coil pattern 311, extend to the third surface 103 of the body 100, and be connected to the first external electrode 610. Additionally, the second lead-out portion 332 may be connected to the outer end of the second coil pattern 312 and extend to the fourth surface 104 of the body 100 to be connected to the second external electrode 620.

Referring to FIG. 4, the coil 300 of this embodiment may further include a via 320 connecting the first coil pattern 311 and the second coil pattern 312. In detail, the via 320 may penetrate the support member 200 and connect the inner ends of the innermost turns of each of the first and second coil patterns 311 and 312 to each other.

On the other hand, the via 320 of this embodiment may have a circular shape based on the L-W cross section, and the diameter may decrease from one surface of the support member 200 toward the inside, and then increase again from the inside toward the other surface. For example, the cross-sectional area of the via 320 on the L-W cross section may be minimal inside the support member 200.

The above feature may be implemented by irradiating a laser from both sides of the support member 200 when processing a via hole in the support member 200 so that the via 320 may be disposed. However, the scope of the present disclosure is not limited thereto and may vary depending on the thickness Ts of the support member 200, the intensity and time of the irradiated laser, etc. For example, the via 320 may be formed in a cylindrical shape or a tapered shape.

As the coil 300 includes the above-described configurations, the signal input to the first external electrode 610 may be output to the second external electrode 620 through the first lead-out portion 331, the first coil pattern 311, the via 320, the second coil pattern 312, and the second lead-out portion 332. Through this structure, each component of the coil 300 may function as a single coil connected between the first and second external electrodes 610 and 620.

At least one of the coil patterns 311 and 312, the vias 320, and the lead-out portions 331 and 332 may include at least one conductive layer.

For example, when the first coil pattern 311, the via 320, and the first lead-out portion 331 are formed by plating on one surface of the support member 200, each of the first coil pattern 311, the via 320, and the first lead-out portion 331 may include a seed layer and an electroplating layer. The seed layer may be formed by electroless plating or vapor deposition methods such as sputtering. Each of the seed layer and the electroplating layer may have a single-layer structure or a multilayer structure. The multi-layered electroplating layer may be formed with a conformal film structure in which one electroplating layer is covered by another electroplating layer, and may also be formed in a shape in which another electroplating layer is laminated only on one surface of one electroplating layer. The seed layer of the first coil pattern 311, the seed layer of the via 320, and the seed layer of the first lead-out portion 331 may be formed as one body, so that no boundary is formed therebetween, but the present disclosure is not limited thereto.

The electroplating layer of the first coil pattern 311, the electroplating layer of the via 320, and the electroplating layer of the first lead-out portion 331 may be formed integrally, so that no boundary is formed therebetween, but the present disclosure is not limited thereto.

Each of the coil patterns 311 and 312, vias 320, and lead-out portions 331 and 332 may include a conductive material such as copper (Cu), aluminum (Al), silver (Ag), tin (Sn), gold (Au), nickel (Ni), lead (Pb), titanium (Ti), chromium (Cr), molybdenum (Mo) or alloys thereof, or the like, but is not limited thereto.

Referring to FIGS. 1 to 4, the coil component 1000 according to this embodiment may include an insulating wall 400 that covers the side of the coil 300 and fills between respective turns of the coil 300.

The insulating wall 400 may function as a plating resist when forming the coil 300 through electrolytic plating, and may be configured to remain without being removed even after forming the coil 300, thereby increasing the insulation between the coil 300 and the body 100, and preventing short circuits or current leakage between adjacent turns of the coil 300.

Referring to FIG. 3, the insulating wall 400 of this embodiment may be formed to include a plurality of layers, and an interface Iw may be formed between respective layers of the insulating wall 400. To form the coil 300 with a high aspect ratio, the height Hw of the insulating wall 400 must also be formed high. To maintain stable placement and alignment of the insulating wall 400, it may be preferable to form it in multiple layers as in this embodiment.

In this case, the height Hw of the insulating wall 400 is based on one surface or the other surface of the support member 200 in contact with the insulating wall 400. For example, the height Hw of the insulating wall 400 disposed on one surface of the support member 200 may be a value obtained by measuring the distance from one surface of the support member 200 to the end of the insulating wall 400 in the first direction (T). In addition, the height Hw of the insulating wall 400 disposed on the other surface of the support member 200 may be a value obtained by measuring the distance from the other surface of the support member 200 to the end of the insulating wall 400 in the first direction (T).

The height Hw of the insulating wall 400 may, for example, refer to the arithmetic average of at least three or more values among respective dimensions of a plurality of line segments connecting the outermost boundary of the insulating wall 400 illustrated in the image in the first direction (T) and spaced apart from each other in the second direction (L), based on an optical microscope image or a scanning electron microscope (SEM) image of the second direction (L)-first direction (T) cross section taken from the central portion of the third direction (W) of the coil component 1000. In this case, the plurality of line segments may be equally spaced from each other, but the scope of the present disclosure is not limited thereto.

In the case of the coil component 1000 of this embodiment, the height Hw of the insulating wall 400 in the first direction (T) may be equal to or higher than the height Hf of the upper surface of the insulating film 500 in the first direction (T). For example, the end of the insulating wall 400 may be coplanar with the insulating film 500 or may protrude beyond the insulating film 500.

Referring to FIG. 3, the line width LWw of the insulating wall 400 may be minimum at the interface Iw between respective layers of the insulating wall 400. Accordingly, the side of the coil 300 may include a protrusion P1 in an area adjacent to the interface Iw between respective layers of the insulating wall 400.

On the other hand, the number of protrusions P1 formed on one surface of each turn of the coil 300 may be less than the number of layers included in the insulating wall 400.

In the coil component 1000 according to this embodiment, the line width LWw of the insulating wall 400 filling between respective turns of the coil 300 may be in a range from 3 μm to 8 μm.

TABLE 1

| | Line width | | Short/Leakage Defect | |
|---|---|---|---|---|
| Experiment | (LWw) of | | (Occurrence: NG, Non- | Ls Change |
| Example | Insulating Wall | | occurrence: OK) | Rate |
| #1 | 1 | μm | NG | +16% |
| #2 | 2 | μm | NG | +15% |
| #3 | 3 | μm | OK | +13% |
| #4 | 4 | μm | OK | +11% |
| #5 | 5 | μm | OK | +9.5% |
| #6 | 6 | μm | OK | +6.5% |
| #7 | 7 | μm | OK | +4.5% |
| #8 | 8 | μm | OK | +3% |
| #9 | 9 | μm | OK | +1.5% |
| #10 | 10 | μm | OK | 0% |

Table 1 above is a table illustrating whether a short circuit or current leakage defect occurs between adjacent turns of the coil 300, and the change rate of inductance capacity, as the line width LWw of the insulating wall 400 of the coil component 1000 is changed. The sample used in the experiment was a coil component 1000 with a length of 1.0 mm, a width of 0.7 mm, and a thickness of 0.65 mm, the number of turns of the coil 300 was 10.5 turns, and the line width LWw of the standard insulating wall 400 was set to 10 μm. Five samples were used in each experimental example, and if any short circuit or current leakage occurred, it was marked as “NG,” and if no short circuit or current leakage occurred, it was marked as “OK.” In the case of inductance capacity (Ls) change rate, it was set as an effective effect when it increased by 3% or more compared to the standard capacity, and the arithmetic average value of 5 samples was recorded.

Referring to Table 1, when the line width LWw of the insulating wall 400 was less than 3 μm, a short circuit or current leakage occurred between adjacent turns of the coil 300. On the other hand, when the line width LWw of the insulating wall 400 exceeds 8 μm, the rate of change in inductance capacity (Ls) compared to the reference capacity was less than 3%.

Therefore, when the line width LWw of the insulating wall 400 filling between respective turns of the coil 300 is formed to be 3 μm or more and 8 μm or less, it may have the effective effect of increasing the inductance capacity (Ls) by 3% or more while preventing short circuits or current leakage between adjacent turns of the coil 300.

Referring to FIGS. 1 and 2, the insulating wall 400 of this embodiment may be disposed to contact at least one of the third surface 103 and the fourth surface 104 of the body 100. The insulating wall 400 may be disposed to fill the area between respective turns of the coil 300 as well as the area on the support member 200 where the coil 300 is not formed.

For example, the insulating wall 400 may be disposed with a wide line width in an area opposite to the lead-out portions 331 and 332 with the support member 200 as the center. Additionally, the insulating wall 400 may also cover the inner surface of the innermost turn of the coil 300 and may also cover the outer side surface of the outermost turn.

The insulating wall 400 may be a known resist film, and may be formed by laminating and curing a resist film or applying and curing a resist film material, but is not limited thereto.

As a method of stacking a resist film, for example, a hot press process of pressurizing at a high temperature for a certain period of time, then reducing the pressure and cooling to room temperature, followed by a method of lowering the temperature through a cold press process to separate the work tool and the like, may be used.

As a method of applying the resist film, for example, a screen printing method in which ink is applied with a squeeze, a spray printing method in which ink is misted and applied, or the like, may be used.

Afterwards, the insulating wall 400 may be formed by applying a photolithography method to the semi-cured resist film.

Referring to FIGS. 2 to 4, the coil component 1000 according to this embodiment may include an insulating film 500 disposed between the insulating walls 400 and covering the upper surface of the coil 300.

The insulating film 500 is a component that insulates between the upper surface of the coil 300 and the body 100, and since the coil component 1000 according to this embodiment has a double insulation structure of the insulating wall 400 and the insulating film 500, the insulation reliability between the coil 300 and the body 100 may be improved.

Referring to FIGS. 2 and 3, the height Hf of the insulating film 500 of this embodiment based on one surface of the support member 200 may be formed to be equal to or lower than the height Hw of the insulating wall 400.

In the coil component 1000 according to this embodiment, the height Hf of the insulating film 500 is formed to be higher than the height Hw of the insulating wall 400, so that the upper surface of the insulating wall 400 and the upper surface of the coil 300 are formed. Compared to the case where the insulating film 500 is formed to be lower in height, more space for placing the magnetic material may be secured within the body 100, and the effective volume may be increased, thereby improving the inductance characteristics.

In the coil component 1000 according to this embodiment, the thickness Tf of the insulating film 500 in the first direction (T) may be in a range from 6 μm to 8 μm.

TABLE 2

| | | | Penetration Defect of | Effective |
|---|---|---|---|---|
| | Thickness (Tf) | | Magnetic Material | Volume |
| Experimental | of Insulating | | (Occurrence: NG, Non- | Change |
| Example | Film | | occurrence: OK) | Rate |
| #1 | 4 | μm | NG | +8.4% |
| #2 | 5 | μm | NG | +7.2% |
| #3 | 6 | μm | OK | +6% |
| #4 | 7 | μm | OK | +4.8% |
| #5 | 8 | μm | OK | +3.6% |
| #6 | 9 | μm | OK | +2.4% |
| #7 | 10 | μm | OK | +1.2% |

Table 2 above illustrates whether a defect occurs in which the magnetic material of the body 100 penetrates into the coil 300 as the thickness Tf of the insulating film 500 of the coil component 1000 is changed, and the rate of change of effective volume. The sample used in the experiment had a length of 1.0 mm, a width of 0.7 mm, and a thickness of 0.65 mm. The number of turns of the coil 300 is 10.5 turns, and the thickness Tf of the standard insulating film 500 is set to 11 μm. Five samples were used in each experimental example, and if any short circuit or current leakage occurred, it was marked as “NG,” and if no short circuit or current leakage occurred, it was marked as “OK.” In the case of effective volume change rate, it was set as an effective effect when it increased by 3% or more compared to the standard volume, and the arithmetic average value of 5 samples was recorded.

Referring to Table 2, when the thickness Tf of the insulating film 500 was less than 6 μm, a defect occurred in which the magnetic material of the body 100 penetrated into the coil 300. On the other hand, when the thickness Tf of the insulating film 500 exceeded 8 μm, the change rate of the effective volume compared to the reference volume was less than 3%.

Therefore, when the thickness Tf of the insulating film 500 covering the upper surface of the coil 300 is formed from 6 μm to 8 μm, a short circuit due to magnetic material penetration between the upper surface of the coil 300 and the body 100 is prevented, and the effective volume of the coil component 1000 is increased by 3% or more.

The insulating film 500 may include a known insulating material such as Parylene, may be formed by a method such as vapor deposition, but is not limited thereto, and may also be formed by laminating an insulating film on the upper surface of the coil 300 between the insulating walls 400.

Referring to FIGS. 1 and 2, external electrodes 610 and 620 may be disposed on the body 100 and connected to the coil 300. In detail, the first external electrode 610 may be disposed on the third surface 103 of the body 100 and contact-connected to the first lead-out portion 331, and the second external electrode 620 may be disposed on the fourth surface 104 of the body 100 and connected to the second lead-out portion 332.

The first external electrode 610 may be disposed on the third surface 103 of the body 100 and extend to at least portions of the first surface 101, the second surface 102, the fifth surface 105, and the sixth surface 106 of the body 100. Additionally, the second external electrode 500 may be disposed on the fourth surface 104 of the body 100, and extend to at least portions of the first surface 101, the second surface 102, the fifth surface 105, and the sixth surface 106 of the body 100.

When the coil component 1000 according to this embodiment is mounted on a circuit board, the external electrodes 610 and 620 electrically connect the coil component 1000 to a circuit board, etc. For example, the first and second external electrodes 610 and 620, which extend to the first surface 101 of the body 100 and are spaced apart from each other, may be electrically connected to a connection portion of the circuit board.

The external electrodes 610 and 620 may be formed of a conductive material, such as copper (Cu), aluminum (Al), silver (Ag), tin (Sn), gold (Au), nickel (Ni), lead (Pb), chromium (Cr), titanium (Ti), alloys thereof, or the like, but the present disclosure is not limited thereto.

Each of the external electrodes 610 and 620 may be formed of multiple layers. For example, the first external electrode 610 may include a first layer in contact with the first lead-out portion 331 and a second layer disposed on the first layer. In this case, the first layer may be a conductive resin layer containing conductive powder containing at least one of copper (Cu) and silver (Ag) and an insulating resin, or may be a copper (Cu) plating layer. The second layer may have a double-layer structure of a nickel (Ni) plating layer/tin (Sn) plating layer.

On the other hand, the coil component 1000 according to this embodiment may further include an external insulating layer that covers the third to sixth surfaces 103, 104, 105 and 106 of the body 100, excluding the area where the external electrodes 610 and 620 are disposed.

The external insulating layer, for example, may be formed by coating and curing an insulating material including an insulating resin on the surface of the body 100. In this case, the insulating layer may include at least one of thermoplastic resins such as polystyrene, vinyl acetate, polyester, polyethylene, polypropylene, polyamide, rubber, and acrylic, thermosetting resins such as phenol-based, epoxy-based, urethane-based, melamine-based, and alkyd-based resins, and photosensitive insulating resins.

### Modification of First Embodiment

FIG. 5 relates to a first modification (1000′) of the first embodiment and is a diagram corresponding to FIG. 4.

Comparing FIG. 5 with FIG. 4, the shape of the via 320 in this modification is different.

Therefore, in describing this modification, only the shape of the via 320 that is different from the first embodiment will be described. For the remaining configurations of these embodiments, the description in the first embodiment may be applied as is.

Referring to FIG. 5, the via 320 of this modified example may have a circular shape based on the L-W cross section, and may have a shape whose diameter decreases from one surface of the support member 200 to the other surface. For example, the cross-sectional area of the via 320 on the L-W cross section may be minimal on the other surface of the support member 200 and may have a tapered shape.

The above feature may be implemented by irradiating the laser only on one surface of the support member 200 when processing a via hole in the support member 200 so that the via 320 may be placed.

On the other hand, in the case of the support member 200 with a thin thickness, it is easy to form a via hole even if the laser is irradiated from only one surface, and thus, it may be preferable that the thickness (Ts′) of the support member 200 of this modified example is thinner than that of the first embodiment.

The coil component 1000′ according to this modification may reduce the risk of voids occurring within the via 320 as metal is formed in the narrow via hole during the coil 300 plating process.

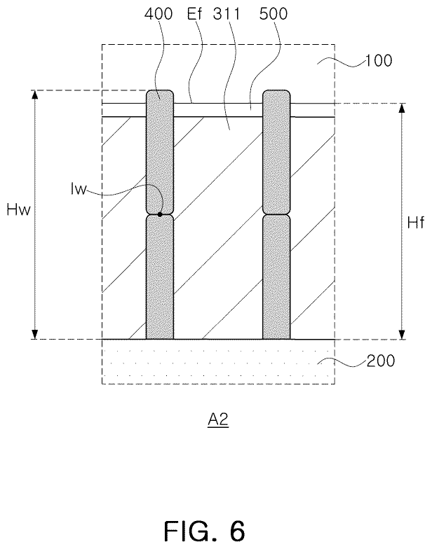

FIG. 6 relates to a second modification (A2) of the first embodiment and is a diagram corresponding to FIG. 3.

Comparing FIG. 6 with FIG. 3, the difference is that the end of the insulating wall 400 protrudes more than the upper surface Ef of the insulating film 500 in this modified example.

Therefore, in describing this modification, only the insulating wall 400 and the insulating film 500, which are different from the first embodiment, will be described. For the remaining configurations of these embodiments, the description in the first embodiment may be applied as is.

Referring to FIG. 6, in this modified example, the height Hf of the insulating film 500 based on one surface of the support member 200 may be formed to be lower than the height of the end of the insulating wall 400. For example, the upper surface Ef of the insulating film 500 may be formed between the insulating walls 400 and inward from the end of the insulating walls 400.

In the case of this modification, the insulating film 500 moves further inward between the insulating walls 400 to secure space for the magnetic material of the body 100, so the inductance characteristics may be further improved as the effective volume is further increased.

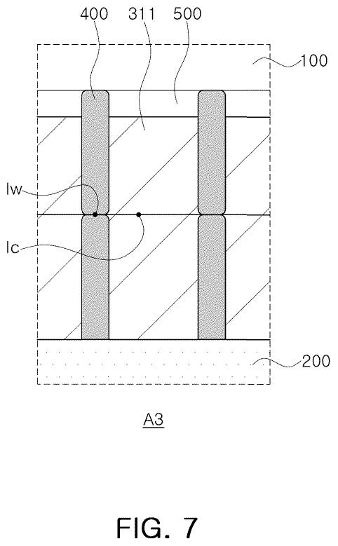

FIG. 7 relates to a third modification (A3) of the first embodiment and is a diagram corresponding to FIG. 3.

Comparing FIG. 7 with FIG. 3, the coil 300 of this modification is different from the first embodiment in that it includes a plurality of layers.

Therefore, in describing this modification, only the multilayer structure of the coil 300, which is different from the first embodiment, will be described. For the remaining configurations of these embodiments, the description in the first embodiment may be applied as is.

Referring to FIG. 7, in this modified example, the coil 300 includes a plurality of layers, and an interface Ic may be formed between respective layers of the coil 300. For example, an interface Ic may be formed between respective layers in the first coil pattern 311.

Additionally, the line width at each turn of the coil 300 may be maximum at the interface Ic of the coil 300.

In addition, the interface Ic of the coil 300 is located at the same level as the interface Iw of the insulating wall 400, so that they may be coplanar with each other.

The above feature of this modified example is that, for example, one layer of the insulating wall 400 having a multilayer structure is first disposed, and then one layer of the coil 300, which also has a multilayer structure, is disposed, and may be implemented by repeating this process. However, the present disclosure is not limited thereto, and even if the coil (300) forming process is separated, it may be formed integrally without an interface between layers.

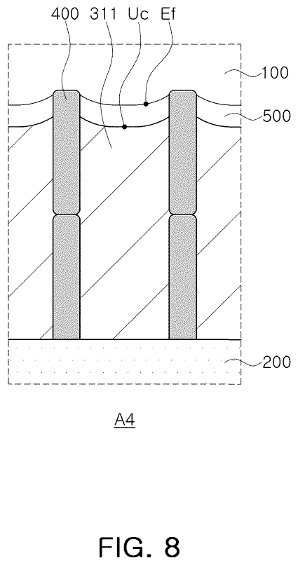

FIG. 8 relates to a fourth modification (A4) of the first embodiment and is a diagram corresponding to FIG. 3.

Comparing FIG. 8 with FIG. 3, the insulating film 500 of this modification is different in that the upper surface Ef has a concave shape.

Therefore, in describing this modification, only the shape of the upper surface Ef of the insulating film 500, which is different from the first embodiment, will be described. For the remaining configurations of these embodiments, the description in the first embodiment may be applied as is.

Referring to FIG. 8, in this modified example, the upper surface Uc of the coil 300 may have a concave shape toward the support member 200. For example, the upper surface Uc of the first coil pattern 311 may be formed concave in the first direction (T).

Additionally, the upper surface Ef of the insulating film 500 may be concave toward the support member 200 along the shape of the upper surface Uc of the coil 300. For example, the insulating film 500 may be conformally disposed along the shape of the upper surface Uc of the first coil pattern 311 and formed concave in the first direction (T).

In the case of this modification, the insulating film 500 covers the end of the insulating wall 400 and the adjacent area, so that the insulation between the coil 300 and the body 100 may be improved, and by disposing the magnetic material of the body 100 in the area where the upper surface Ef of the insulating film 500 is formed to be concave, the effective volume may be increased and the inductance characteristics may be improved.

### Second Embodiment and Modifications Thereof

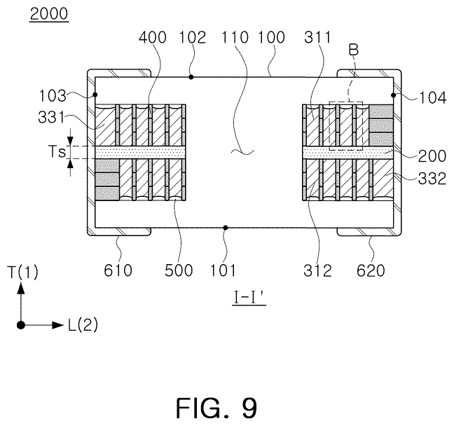

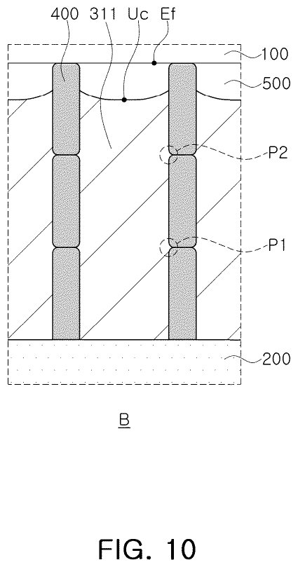

FIG. 9 illustrates a coil component 2000 according to a second embodiment and is a diagram corresponding to FIG. 2. FIG. 10 is an enlarged view of area B of FIG. 9.

Comparing FIGS. 9 and 2 and FIGS. 10 and 3 respectively, in the case of the coil component 2000 according to this embodiment, the difference is that the insulating wall 400 has a three-layer structure, the upper surface Uc of the coil 300 has a concave shape, and two or more protrusions P1 and P2 are formed on each turn side of the coil 300.

Therefore, in describing this embodiment, only the three-layer structure of the insulating wall 400, the shape of the upper surface Uc of the coil 300, and the protrusions P1 and P2 formed on the sides of each turn of the coil 300, different from those of the first embodiment, will be described, and for the remaining components of this embodiment, the description in the first embodiment may be applied as is.

Referring to FIGS. 9 and 10, the insulating wall 400 of this embodiment may be formed of three or more layers.

As the insulating wall 400 is formed of three or more layers, the aspect ratio of the coil 300 disposed between the insulating wall 400 may become higher. As the number of turns increases within the coil component 2000 of a limited size, the inductance capacity may increase, and as the surface area of the coil 300 increases, Rdc may also be reduced.

Referring to FIG. 10, the coil component 2000 of this embodiment may have a concave shape in which the upper surface Uc of the coil 300 is concave toward the support member 200.

On the other hand, the insulating film 500 of this embodiment may be formed flatly at the same level as the end of the insulating wall 400. For example, the insulating film 500 is not formed conformally according to the shape of the upper surface Uc of the coil 300, but may be disposed to fill the space of the upper surface Uc of the coil 300 between the insulating walls 400.

The coil component 2000 according to this embodiment may improve the insulation reliability between the body 100 and the coil 300 by thickly arranging the insulating film 500 in areas where the insulation between the body 100 and the coil 300 is weak.

On the other hand, in this embodiment, two or more protrusions P1 and P2 may be formed on each turn side of the coil 300. For example, since the insulating wall 400 has a three-layer structure, at least two protrusions P1 and P2 may be formed on the side of the coil 300 in the area adjacent to the interface between respective layers of the insulating wall 400.

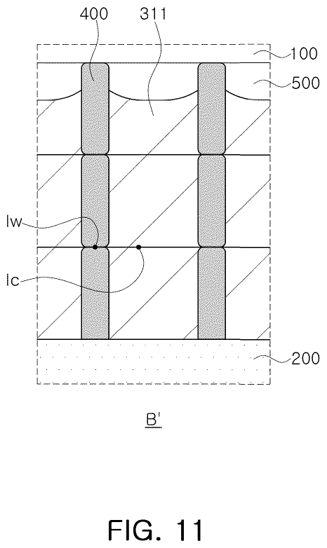

FIG. 11 relates to a modification (B′) of the second embodiment and is a diagram corresponding to FIG. 10.

Comparing FIG. 11 with FIG. 10, the coil 300 of this modification is different from the second embodiment in that it includes a plurality of layers.

Therefore, in describing this modification, only the multilayer structure of the coil 300, which is different from the second embodiment, will be described. For the remaining configurations of these embodiments, the description in the second embodiment may be applied as is.

Referring to FIG. 11, in this modified example, the coil 300 may be formed of three or more layers, and an interface Ic may be formed between respective layers of the coil 300. For example, an interface Ic may be formed between respective layers in the first coil pattern 311.

Additionally, the line width at each turn of the coil 300 may be maximum at the interface Ic of the coil 300.

In addition, the interface Ic of the coil 300 is located at the same level as the interface Iw of the insulating wall 400, so that they may be coplanar with each other.

The above feature of this modified example is that, for example, one layer of the insulating wall 400 having a three-layer structure is first disposed, and then one layer of the coil 300, which also has a three-layer structure, is disposed, and may be implemented by repeating this process. However, the present disclosure is not limited thereto, and even if the coil 300 forming process is separated, it may be formed integrally without an interface between layers.

### Process of Manufacturing Coil Component

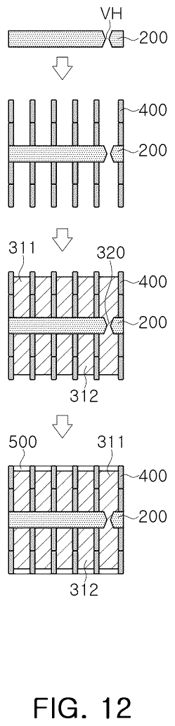

FIG. 12 is a diagram schematically illustrating a portion of the process of manufacturing a coil component 1000 illustrated in FIG. 4.

Referring to FIG. 12, first, the support member 200 may be prepared and a via hole (VH) may be processed at the location where the via 320 will be placed.

Next, after stacking the resist film in multiple layers, the insulating wall 400 corresponding to the shape of the coil 300 may be patterned through exposure and development. In this case, the insulating wall 400 has two or more layers, and an interface may be formed between respective layers.

Next, the coil 300 may be formed through electrolytic plating. For example, the first and second coil patterns 311 and 312 may be disposed to fill the space between the insulating walls 400, and the via 320 may also be formed integrally.

Next, an insulating film 500 may be disposed on each of the upper surfaces of the first coil pattern 311 and the second coil pattern 312. In this case, the upper surface of the insulating film 500 may be formed so as not to protrude beyond the end of the insulating wall 400.

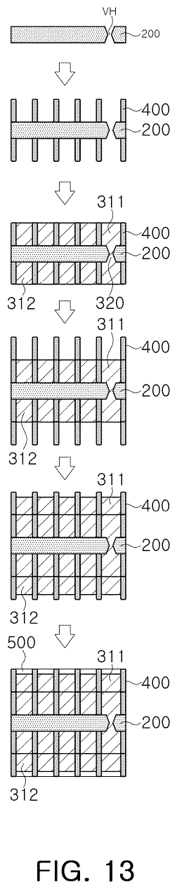

FIG. 13 is a diagram schematically illustrating a portion of the process of manufacturing a coil component including a coil 300 having a multilayer structure as illustrated in FIG. 7.

Referring to FIG. 13, first, the support member 200 may be prepared and a via hole (VH) may be processed at the location where the via 320 will be placed.

Next, after arranging the resist film in a single layer, the first layer of the insulating wall 400 corresponding to the shape of the coil 300 may be patterned through exposure and development.

Next, the first layer of the coil 300 may be formed through electrolytic plating. For example, the first and second coil patterns 311 and 312 may be disposed to fill the space between the insulating walls 400, and the via 320 may also be formed integrally. In this case, the coil 300 may be formed at the same height as the end of the insulating wall 400 or at a lower height.

Next, the second layer of the insulating wall 400 may be placed on the first layer of each of the coil 300 and the insulating wall 400. In the case of the second layer of the insulating wall 400, after placing a resist film in a single layer on the first layer of each of the coil 300 and the insulating wall 400, the two-layer shape of the coil 300 and the corresponding two-layer insulating wall 400 may be patterned through exposure and development.

Next, the second layer of the coil 300 may be formed through electrolytic plating. For example, two layers of each of the first and second coil patterns 311 and 312 may be disposed to fill the space between the insulating walls 400. An interface may be formed between the first and second layers of the coil 300.

Next, an insulating film 500 may be disposed on each of the upper surfaces of the first coil pattern 311 and the second coil pattern 312. In this case, the upper surface of the insulating film 500 may be formed so as not to protrude beyond the end of the insulating wall 400.

As set forth above, according to an embodiment, a coil with a high aspect ratio may be easily formed through an insulating wall, and current leakage between adjacent turns may be prevented.

According to an embodiment, inductance characteristics of a coil component may be improved by securing a space in a body in which a magnetic material may be disposed.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
a support member disposed within the body and having a first surface and a second surface facing each other in a first direction;
a coil disposed on at least one of the first and second surfaces of the support member and protruding from a respective surface of the support member in the first direction, the coil having a plurality of turns, and including a lower surface in contact with the respective surface of the support member and an upper surface facing the lower surface;
an insulating wall filling a gap between adjacent turns of the coil;
an insulating film disposed between adjacent insulating walls and covering the upper surface of the coil; and
an external electrode disposed on the body and connected to the coil,
wherein the insulating wall includes a plurality of layers with an interface therebetween, and
a height of the insulating wall in the first direction from the respective surface of the support member is greater than or equal to a height of an upper surface of the insulating film first direction from the respective surface of the support member.

2. The coil component of claim 1, wherein a line width of the insulating wall is minimum at the interface between adjoining layers among the plurality of layers of the insulating wall.

3. The coil component of claim 1, wherein the insulating wall comprises three or more layers.

4. The coil component of claim 1, wherein a line width of the insulating wall filling between the respective turns of the coil is in a range from 3 μm to 8 μm.

5. The coil component of claim 1, wherein a thickness of the insulating film in the first direction is in a range from 6 μm to 8 μm.

6. The coil component of claim 1, wherein the side of the coil includes at least one protrusion protruding toward the interface of the insulating wall.

7. The coil component of claim 6, wherein a line width at each turn of the coil is maximum in an area adjacent to the protrusion.

8. The coil component of claim 1, wherein the upper surface of the coil is concave toward the support member.

9. The coil component of claim 8, wherein the upper surface of the insulating film is concave toward the support member along a shape of the upper surface of the coil.

10. The coil component of claim 1, wherein the coil includes a plurality of layers, and an interface between respective layers of the coil.

11. The coil component of claim 10, wherein a line width of the coil is maximum at the interface of the coil.

12. The coil component of claim 10, wherein the coil is formed of three or more layers.

13. The coil component of claim 10, wherein the interface of the insulating wall and the interface of the coil are coplanar with each other.

14. The coil component of claim 1, wherein a thickness of the support member in the first direction is 50 μm or less.

15. The coil component of claim 1, wherein the body further includes a third surface and a fourth surface opposing each other in a second direction, perpendicular to the first direction, and
the coil includes a first coil pattern disposed on the first surface of the support member, a first lead-out portion extending from an outer end of the first coil pattern to the third surface, a second coil pattern disposed on the second surface of the support member, a second lead-out portion extending from an outer end of the second coil pattern to the fourth surface, and a via connecting the first coil pattern and the second coil pattern.

16. The coil component of claim 15, wherein the insulating wall is in contact with at least one of the third surface and the fourth surface.

17. The coil component of claim 15, wherein a cross-sectional area of the via is minimum on the second surface of the support member on a cross section, perpendicular to the first direction and passing through the via.

18. The coil component of claim 15, wherein on a cross section perpendicular to the first direction and passing through the via, a cross-sectional area of the via is minimum on the inside of the support member.

19. A coil component comprising:
a body;
a support member disposed within the body;
a coil disposed on the support member, having a plurality of turns, and including a lower surface in contact with the support member and an upper surface facing the lower surface;
an insulating wall disposed between respective turns of the coil;
an insulating film disposed between the insulating walls and interposed between the upper surface of the coil and the body; and
an external electrode disposed on the body and connected to the coil,
wherein the insulating wall includes a plurality of layers, with an interface therebetween, a line width of the insulating wall being minimum at the interface, and
the upper surface of the coil has a concave shape toward the support member.

20. The coil component of claim 19, wherein a line width of the insulating wall disposed between respective turns of the coil is in a range from 3 μm to 8 μm, a thickness of the insulating film in the first direction is in a range from 6 μm to 8 μm, and a thickness of the support member in the first direction is 50 μm or less.

21. A coil component comprising:
a support member;
a coil disposed on a surface of the support member, the coil having a lower surface contacting the surface of the support member and an upper surface opposing the lower surface in a first direction, and comprising a plurality of turns with gaps therebetween;
an insulating wall disposed in the gaps between the plurality of turns and comprising a plurality of layers with an interface therebetween, a line width of the insulating wall being smallest at the interface;
an insulating film disposed on the upper surface of the coil,
wherein a distance of an upper surface of insulating film from the surface of support member is less than or equal to a distance of an upper surface of the insulating wall from the surface of the support member.

22. The coil component of claim 21, further comprising a body embedding the support member and the coil, wherein the insulating film electrically insulates the coil from the body.

23. The coil component of claim 21, wherein a width of the plurality of coil turns is maximum adjacent the interface between the plurality of layers of the insulating wall.
